(19) United States
(12) Patent Application Publication
(10) Pub. No.: US 2022/0164716 A1
(43) Pub. Date: May 26, 2022

(54) FullPlate, The Mobile Application for Covid-19 Compliant and Contact Free (all likenesses) Dining Services

(71) Applicants: Jasper Lee Mills, III, Albany, NY (US); Lorenzo Triblet, II, Niskayuna, NY (US)

(72) Inventors: Jasper Lee Mills, III, Albany, NY (US); Lorenzo Triblet, II, Niskayuna, NY (US)

(21) Appl. No.: 17/100,941

(22) Filed: Nov. 22, 2020

(51) Int. Cl. G06Q 10/02; G06Q 40/00; G06Q 20/32

(52) U.S. Cl. CPC G06Q 10/02; G06Q 20/327; G06Q 40/125

(57) ABSTRACT

A completely interactive dining mobile application. Includes an online reservation system, which targets both date and time of reservation and food service. Automatic prompts provide consumes with instruction as to promote safety and CDC compliance. Interactive design allows for consumers to converse with restaurant partner using a series of built in responses as to promote safety, convenience and efficiency. Multiple touch free payment methods are available through the application. Automatic payment to restaurant partners and FullPlater independent contractors, through built in accounting software.

Full Plate is a mobile/web dining application that assists restaurants and consumers with a contact free, Covid-19 compliant dining experience which includes dine-in services, pick up and delivery.

Consumers are able to search the application for their favorite restaurants. When the establishment appears on the app the consumer is then made aware of number of patrons currently inside of the restaurant for safety and social distance purposes.

Dine-in—Customer locates restaurant and places order. Each order is specific to that patron as they are required to attach a name to each order as to avoid confusion on the part of the server. Customers can pay for the entire order or split the check with someone in their party. Customer then tells the establishment when they plan on being at the restaurant, what time they would like their food delivered to the table and how long they would like for their dining experience to last. After receipt of confirmation of order the customer is provided an arrival button on the application to notify the restaurant that they have arrived in the parking lot. The customer is then required complete a COVID questionnaire prior to being welcomed into the establishment. The restaurant then welcomes the customer inside of the restaurant once the table has been sanitized and the required number of patrons have exited the establishment thus making room for the incoming party. The restaurant is notified once the dining time is expired so that the wait staff can assist the consumer and usher them out. Once the patron has left the application allows the restaurant to update the number of consumers inside of the building.

Customers also have the option of selecting a Contact Free dine-in experience. During this experience customers will not have the option to select which time they would like for their food to be delivered to the table because their reservation time will also serve as their food delivery time. Once customers arrive to the restaurant they will take the same steps as the traditional FullPlate dining experience (arrival button, COVID-19 questionnaire). However, FullPlate instructs restaurant staff to have the order completed at the time that the customer is welcomed into the restaurant. Upon entering the restaurant, customers will check in with the hostess while their order is delivered to their table. Customers will be ushered to their table where their food, and to go containers will be waiting for them. Restaurant staff is instructed not to have any contact with the customer unless said contact is initiated by the customer.

Take-out—Customer can place and pay for an order through the application and choose what time they would like for their food to be ready. As with dining, customer is made aware through the app how many patrons are inside of the establishment. Restaurant sends confirmation of the order and informs the customer to hit the arrival button once they arrive at the establishment. When customer arrives and hits the arrival button on the app they are provided with a message to wait until they are either invited into the restaurant or that their staff is on their way out with their order. Restaurant provides notification to consumer welcoming them in to pick up order or telling them that their order will be delivered to their vehicle. Once the order is complete the restaurant is provided a button to adjust the number of patrons inside of the building.

Delivery—Full plate helps to facilitate contact free delivery to any restaurant currently providing delivery services. Patrons are able to place and pay for order on the app. Patrons are provided, by the restaurant, with an approximate time of delivery, notification once the driver has left to deliver, and confirmation that the order has been delivered and is at their door for patron to retrieve. Once patron has received the order, they can firm through the app so that the delivery person can exit the premises. All food will be delivered in sealed tamper-proof bags, and drivers are required to answer a weekly COVID questionnaires and wear FullPlate Masks during the delivery, in order to promote safety and cleanliness.

Be a full plater—a portion of the application where people are permitted to apply to be a part of the full plate team. Web based training is provided through the application. Those accepted are provided with access to all of the documentation required to contract with food providers for their use of the application. Full platers will be provided with a commission for each restaurant that uses the app through their efforts.

1. A web based mobile application comprising:
Interactive technology which allows for consumers to converse with restaurant partners in order to ensure a safe, convenient and efficient dining experience;
Implemented CDC complaint protocols to promote contact free take out, delivery and dine in services;
Automatic instructions/prompts to consumers tailored to information entered through the application that will notify customers
1. To abide safety protocols
2. when numbers are CDC complaint for customer to enter restaurant
3. Targets reservation date and time
4. Targets time of food delivery;
Touch free payment methods using a variety of platforms;
Built in accounting software for timely payment to restaurant partners and Independent Contractors;
Built in CDC/Covid questionnaire to ensure safety;
Built in questionnaire to allow for contact free application of restaurant partners and independent contractors.
